(19) United States
(12) Patent Application Publication
(10) Pub. No.: US 2013/0263014 A1
(43) Pub. Date: Oct. 3, 2013

(54) METHOD AND SYSTEM FOR SENDING AN INTERACTIVE MESSAGE

(71) Applicant: Ori Chalak, Rosh Ha'Ayin (IL)

(72) Inventor: Ori Chalak, Rosh Ha'Ayin (IL)

(21) Appl. No.: 13/879,095

(22) PCT Filed: Oct. 11, 2011
(86) PCT No.: PCT/IL2011/000809

§ 371 Date: Jun. 13, 2013

Related U.S. Application Data
(60) Provisional application No. 61/392,961, filed on Oct. 14, 2010.

(51) Int. Cl. H04L 12/58

(52) U.S. Cl. CPC H04L 51/04
USPC 715/752

(57) ABSTRACT

A method for sending an interactive message comprises the steps of: a) generating a new message, wherein said message includes widget(s); b) sending said new message to a web server; c)receiving said message in said web server; d) decoding and parsing said received message; e)creating data objects for said message and said widgets; f) storing data related to said message; g) executing server callback actions; h) encoding said message and executing server callfore actions; and i) sending said message to a client software of the recipient.

### FIELD OF THE INVENTION

The present invention relates to the field of electronic messaging. More particularly, the invention relates to a method and system for sending an interactive message to one or more recipients.

### BACKGROUND OF THE INVENTION

Interactive messages exist today in various Email systems. For example, forms in Google Docs can be sent as an Email message. However, although they implement specific interactions like voting, calendar appointment and others, these systems lack capabilities, such as:
They are limited to a two steps process—a message from a computer and a response. For example, in Google Docs the response goes to a web document;
The response does not generate another interactive message;
The response destination cannot be controlled by the original message;
They do not save data traffic by sending a message template signature; and
They do not enforce any trust contract between sender and recipients.

To address these problems and to extend the capabilities of mobile phone Short Message Service (SMS) and Instant Message (IM), which runs over an Internet Protocol (IP), and in a similar manner to enhance the capabilities of Electronic mail (Email), new messaging tools are required.

It is an object of the present invention to provide a system, which is capable of enforcing a messaging contract between sender and recipients.

It is another object of the present invention to provide means for easy, quick and safe message composition.

It is yet another object of the present invention to enable a sequence of interactions by feeding data from an interactive message into the next interactive message in a sequence of messages.

It is still another object of the present invention to provide a method that enables using the relatively limited size of Short Message Service (SMS) for low traffic interactive message over mobile phones, with either low bandwidth or expensive data rate Internet Protocol (IP).

It is a further object of the present invention to enable complex interactive transactions among users.

Other objects and advantages of the invention will become apparent as the description proceeds.

### SUMMARY OF THE INVENTION

The present invention relates to a method for sending an interactive message, which comprises the steps of:
a) generating a new message, wherein said message includes widget(s);
b) sending said new message to a web server;
c) receiving said message in said web server;
d) decoding and parsing said received message;
e) creating data objects for said message and said widgets;
f) storing data related to said message, wherein said stored data includes threads, messages content and widgets;
g) executing server callback event actions;
h) delaying the message if required and activating other event actions upon trigger;
i) encoding said message and executing server callfore event actions (the callfore actions are described in further details later on); and
j) sending said message to a client software of the recipient.

According to an embodiment of the invention, the client software comprises means for:
a) decoding, parsing and rendering the received message;
b) automatically activating of local callfore event actions;
c) activating other event actions upon trigger and whenever the recipient fills-in value(s) or changes the state of the widget(s), then automatically activating of local callback event actions; and
d) decoding and sending a returned message which is in turn another interactive message, whenever said recipient activates a Response widget.

According to an embodiment of the invention, the generation of the new message comprises instantiating an enhanced widget (i.e., HyperWidget as will be described later on), and for each instantiated HyperWidget performing the following tasks: a) assigning a name; b) setting a data frame; c) assigning actions; d) setting more message thread variables; and e) setting message properties. Alternatively, using a template, the generation of the new message comprises filling-in data for each editable field.

According to an embodiment of the invention, the method further comprises verifying by the client whether the template definition (i.e., HyperTemplate) exists on the web server, and if such definition exists, then creating a HyperTemplate signature-based message, or else creating a HyperWidget instances-based message.

According to an embodiment of the invention, the method further comprises implementing a Message Pattern, which is a general reusable solution to a commonly occurring sequence of interactive messages while specific usage cases of it differ by data, wherein said Message Pattern is implemented by using a single or a set of HyperTemplate and wherein at least part of the data may be processed and transferred from an interactive message into the following interactive message. According to some embodiments of the present invention, the first message among the occurring sequence of interactive messages is generated using a HyperTemplate and all other messages that follow said first message may be created by a HyperTemplate or they can be generated directly by a dedicated code. For example, the dedicated code can be a local callback of a sending button or a server callback of the message.

According to one embodiment of the invention, a Message Pattern is formalized as follows: a) A Finite State Machine (FSM) represents the interactive message thread flow, wherein each state, either initial or non-initial, is represented by a HyperTemplate, wherein each initial state is public (i.e. editable and callable), and each non-initial state is protected (i.e. not editable but callable) or public; b) A transition which is represented by a HyperMessage response with data; c) The thread state is derived from all users states; d) A final state represents the thread completion; e) The thread reaches its final state after all users reach their final state; f) When the thread reaches its final state, the thread can be removed from the active threads list and deleted or saved in a history list; and g) every user's FSM may have a timeout after which it transits into a final state.

The present invention further relates to a system for sending an interactive message, which comprises:
a) a client for generating a new message and for sending said new message, wherein said message includes widget(s); wherein the client further includes a template based editor (fill-in and send), and a viewer (view, interact and respond), which may be same as the template based editor; and
b) a web server for receiving said generated message, decoding and parsing said received message, creating data objects for said message and said widgets, storing data related to said message, executing server event actions according to said message and encoding said message; and finally for sending said message to the client software of the recipient.

### BRIEF DESCRIPTION OF THE DRAWINGS

In the drawings:

FIG. 1 schematically illustrates a system for sending an interactive message, according to an embodiment of the present invention; and

FIG. 2 is a flow chart generally illustrating an embodiment of the invention.

### DETAILED DESCRIPTION OF PREFERRED EMBODIMENTS

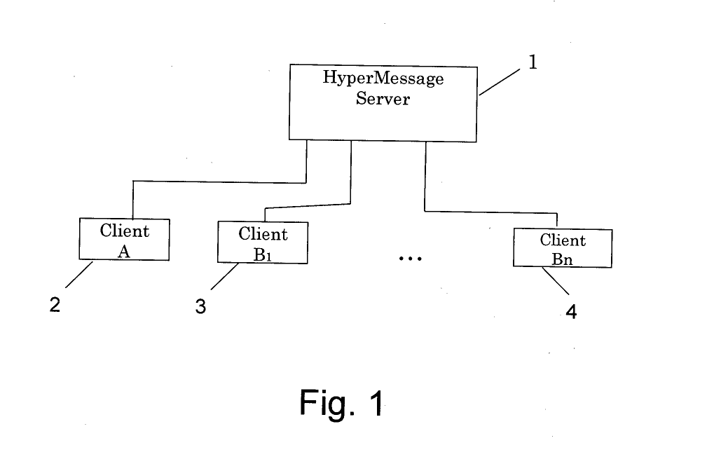

The system of the present invention is implemented over a network that incorporates a server 1 and a plurality of clients 2-4 as shown in FIG. 1. The Figures and the description to follow relate to embodiments of the present invention by way of illustration only. It should be noted that from the following discussion, alternative embodiments of the structures and methods disclosed herein will be readily recognized as viable alternatives that may be employed without departing from the principles of the claimed invention.

The term “Server” refers herein to a web server using standard protocols such as TCP/IP, UDP, HTTP, SMS, MMS, etc. For example, (not limited to):
HTTP for data transfer for clients running over IP;
TCP for notification for clients running over IP;
SMS and MMS for data transfer and notification for mobile clients not running over IP.

The terms “Client” or “Client Software” refer herein to a software code or dedicated application installed or executed in a terminal unit such as a mobile device and/or in various kinds of computers and portable devices such as PC, laptop, notebook, tablet PC, interactive television connecting to a network, etc. For example, the Client may include: a software code embedded on the terminal unit, an on-line HTML application, a social network extension or add-on such as Facebook Platform application, etc.

The term “Server Methods” refers herein to Server actions at internet web sites which are processes running on the server side. Different languages are commonly used for the source code, such as PHP, ASP, Perl and compiled code aka CGI-BIN. Each Server Method can receive values to its predefined parameters. Server Methods perform data manipulation, trigger events, store the result for a later use and/or send the result through a resulting message.

The term “Client Methods” refers herein to client actions performed locally at the client side. It may change data on the client message or on the server and may trigger events. The language to be used for the source code may depend on the client implementation language. For examples: could be used the same language implementing the client software; or Javascript for the HTML view. A client method may call an execution on the server or at any other remote server but is still considered a client method as it was initially invoked at the client side.

The term “HyperMessage” refers herein to an interactive message, wherein the data is serialized from one HyperMessage to the following HyperMessage in a thread, especially for template based messages. Template based messages are described in further details hereinafter.

In general, the term “widget” refers to a GUI element enabling the user setting the content and providing a standard way of data manipulation. The term “HyperWidget” used herein refers to a more strict entity than that typically identified by the general term “widget”. The “HyperWidget” is described furthering greater detail hereinafter.

Unless otherwise indicated, the functions described herein may be performed by executable code and instructions stored in computer-readable medium and running on one or more processor-based systems. However, state machines, and/or hardwired electronic circuits can also be utilized. Furthermore, with respect to the exemplary processes described herein, not all the process states need to be reached, nor do the states have to be performed in the illustrated order. Furthermore, certain process states that are illustrated as being serially performed can be performed in parallel.

The system according to the invention comprises a server and one or more clients as shown with respect to the specific illustrative embodiment shown in FIG. 1. However proxy servers can be provided between the Server and the Clients, as will be appreciated by the skilled person, and more than one server can be used if advantageous in a specific network architecture. The present invention applies to a system containing Server multiplicity and/or the presence of proxy servers, which however are not described herein in detail, for the sake of brevity and since their use will be apparent to the man of the art.

Similarly, while certain examples may refer to a Personal Computer (PC) system or data device, other computer or electronic systems can be used as well, such as, without limitation, an interactive television, a network-enabled personal digital assistant (PDA), a networked entertainment device, a smart phone (e.g., with an operating system and on which a user can install applications) and so on.

HyperMessage Server

The role of the server in manipulating interactive messages (i.e., HyperMessaging) will now be described. The HyperMessage Server contains executable actions—(i.e., Server Methods), and the manipulations include common tasks such as:
Managing users and groups;
Managing Message immediate and delayed Delivery;
Aggregating group responses;
Encoding and decoding messages—Arrived messages can be decrypted and sent messages can be encrypted for security reasons. Optionally, arrived messages can be decompressed and sent messages can be compressed for low data rate reasons. In this context, “encode” refers to the combined process of compressing and encrypting, and “decode” refers to the combined process of decrypting and decompressing.

The HyperMessage Server performs:
HyperMessage thread (i.e., an interactive message thread) management; and
Message event actions (e.g., Callfore, Callback, etc).

According to an embodiment of the present invention, a new message opens a HyperMessage thread automatically for the message and its successive responses. Unlike threads in common mailing servers (such as Gmail), an HyperMessage thread is a more strict entity, characterized by the following:
Thread messages data are stored as follows:
   Thread messages are represented by data objects;
   Each widget of a thread message and its value are represented by object variable and its value;
   Each message variable is stored with its value under the message object.
it manages scheduled executions;
it manages certain features such as group response which aggregates responses into some collective response, according to predefined aggregation rules;
it holds other thread variables such as a list of users participating in the thread, or any message variable which has been defined as a belonging to the scope of the thread; and
it has end of life cycle rules such as timeout, target date or time reached or a satisfaction of some logical condition.

Perform (Interactive) Message Event Actions

For the purpose of clarity we describe the role of callback and callfore events with respect to the system of the present invention. However there might be other events involved in the process, as known to a person skilled in the art. Server/client callback/callfore event actions are described in further details later on.

Definitions of Callback and Callfore Actions

Callback and callfore as well as other event actions can each run locally or at the server. Following descriptions come in chronological order according to the message life cycle:
Server Callfore (as described above) is a server method running on the server before delivering the message, typically in order to gather essential data for the message. For example, if the payment methods are pre-setup at the server then a server Callfore may generate a list of payment methods for the message;
Local callfore is a client method running on the client before the message is rendered, typically to gather essential data for the message. For examples, reading the local time at the device and use the read value somehow;
Local Callback is a client method running on the client immediately following a change in value of the corresponding HyperWidget, for examples, (i) read coordinates from GPS receiver (ii) set values of other widgets of the message as a computational result of the changed value;
Server Callback (as described above) is a server method running on the HyperMessage server when the message reaches to the server. It is typically used to shape the response, set data at the message thread, schedule executions, etc.

The execution order of a composite hierarchical HyperWidget (described below) can be as follows:
Callfore: top-down the hierarchy, at each level (composition) from first to last;
Callback: bottom-up the hierarchy, at each level (composition) from last to first.

A different order can be used, however the order must be well defined to ensure determinism of the execution result.

According to an embodiment of the present invention, the interactive message contains widgets (i.e., HyperWidgets), which can assign Server Callback and/or Server Callfore actions. Such an action is an activation of a Server. Method, which in turn can create or change the message widget values and/or the thread data. According to this embodiment, a message from client A (as indicated by numeral 1 in FIG. 1) to one or more clients B₁ . . . , Bₙ (i.e., the recipients as indicated by numerals 3 and 4 in FIG. 1) goes through the HyperMessage server (as indicated by numeral 1 in FIG. 1). An incoming message (from client to server) is decoded, parsed and its Callback actions are executed in a well-defined order. An outgoing message (from server to client) is parsed, data objects representing the message are created at the message thread, its Callfore actions are executed in a well defined order and it is coded for delivery.

In general, the following process chain is done in the HyperMessage server:
Receiving the message;
Decoding the message data;
Parsing the message;
Executing message callback actions (Server Methods);
Creating an object representing the message at the message thread data space;
For each widget contained in the interactive message performing the tasks of:
   i. Creating a member object representing the widget at the interactive message object; and
   ii. Copying the widget value to the member object.
For each recipient B₁ through Bₙ performing the tasks of:
   i. If message is delayed for a reason such as scheduled to a later time or waiting to other responses for aggregation and some event was triggered, for example, a condition of 50% of responses arrived is satisfied then executing the event method;
   ii. Executing message callfore actions (Server Methods);
   iii. Encoding the message; and
   iv. Sending the message to recipient.

HyperWidget

Overview

According to an embodiment of the invention, HyperWidgets are the building blocks of the HyperMessage. They are more strict entities than general widgets. They can be a simple entity such as a text field widget, or a complex entity such as payment widget. Additionally, HyperWidgets can also contain multimedia elements—from simple elements such as a single picture, including complex element such as a complex presentation encapsulated in Synchronized Multimedia Integration Language (SMIL) format. As a result, all capabilities of Multimedia Messaging Service (MMS) are covered by the HyperMessage service.

We distinguish between a HyperWidget definition and instance. A singleton HyperWidget is a widget that is allowed to have no more than one instance within a HyperMessage.

The following are examples of HyperWidgets in a message, such as the “response” and the “to” fields:

The “Response” HyperWidget enables the message author shaping the response, e.g. label (“Send”, “Respond”, “Forward”, “Pay”, “Run”, etc).

The “To” HyperWidget is a singleton containing the recipient list of this message. Note that the “Response” HyperWidget may instantiate the To HyperWidget at the next message in the chain.

HyperWidget Definition

Each HyperWidget is automatically associated with an object data type at the server side. Upon message incoming from a client to the server an automatic object representing the message data is created at the server's message thread, and automatic member object variable representing each HyperWidget is created at the object representing the message. The variable data-type, name, sub-range and value are derived from various parts of the HyperMessage ecosystem (the HyperMessage ecosystem refers to a case when someone pre-defined the HyperWidget. the message author (or HyperTemplate author) instantiates it, i.e. places it in a hypermessage. its value is changed by the viewer, i.e. the person receives the message, or by an event action. in other words, each view of the HyperWidget is modified by a separate person), such as:
Data-type—HyperWidget definition;
Name and sub-range (where appropriate), for example, range 1 . . . 10 of the type integer—HyperWidget instance;
Value (optional)—HyperWidget view/response through a user set or as a result of an event (e.g., callfore/callback);
Default value (optional)—HyperWidget definition; and
Protection—HyperWidget definition or instance; instance can only set protected but not set unprotected if was set protected at definition. Protected means viewer/responder cannot change values, resulting in enforcement of either the default value or a result of an event such as a callfore or callback.

Since the HyperWidget entity is known at the server and the client, the data transfer is reduced, as a complex HyperWidget is transferred by signature, i.e. HyperWidget ID and its parametric values.

A HyperWidget definition is provided by the HyperMessage system or by any other trusted content provider. It may have several views, such as one or more of the following ones:
Editing view—the structure and content of the HyperWidget at the editor;
Responding view—the structure and content of the HyperWidget at the viewer;
HTML view—an HTML translation of the responding view;
Text view (Optional)—a textual description of the HyperWidget responding view and how to respond it using a text message;
Help view—a text describing the meaning of the HyperWidget definition. Its content is provided by the HyperWidget provider and not by the message author. Hence, the receiver can trust the help view to tell what is behind the HyperWidget. For example, the message author cannot hide the fact that a certain button causes a payment transaction or sends location coordinates read from a given GPS receiver at the client's terminal unit (e.g., a smart-phone). The collection of the message HyperWidget help views can be automatically serialized to provide an automatic message help which is not dependent on, and cannot be blocked by the message author; and
Symbol view—a unique symbol that would visually distinguish the HyperWidget.

HyperWidget Instance

A HyperWidget is instantiated by the message author (either directly or through a message template (i.e., HyperTemplate) or through any software creating a HyperMessage). By doing this, the HyperWidget receives a content that turns it into a meaningful part of a message. The HyperWidget instance contains the following:
Name—as described above will be also automatically reflected by a thread variable;
Sub-range—a content which is inherent part of the HyperMessage.

For example, in a selection (choice) list, the instance must contain the number of choices and a label for each choice. In this case the data-type is Enumerated and the sub-range is the list of labels;
Prolog text (optional); and
Local and Server event actions (optional).

For example, as a default, a “Response” HyperWidget will be instantiated automatically if the message author did not bother to do so.

HyperWidget—Object Oriented Model

According to one embodiment of the invention, the HyperWidget is an Object Oriented entity which applies the following principles:
Composition—a HyperWidget could be a composition of two or more lower level HyperWidget. For example, a composition may contain layout information for rendering e.g. horizontal/vertical etc.
Extension (inheritance)—a HyperWidget could extend (inherit from) another HyperWidget by:
   i. Adding an event (e.g., a callfore or callback);
   ii. Removing an event (e.g., a callfore or a callback);
   iii. Adding a message variable;
   iv. Changing value to a message variable;
Polymorphism—when defining a HyperWidget as a composition, each lower level HyperWidget is allowed to be an extension of the specified HyperWidget type. For example—using polymorphism, a list of Items could be a list of Strings, list of Numbers or list of Payment Methods.

The Object Oriented HyperWidget model provides flexibility and reusability; however the system of the present invention can function correctly also without it. The systems with and without the Object Oriented HyperWidget model are both part of the present invention.

HyperMessage

According to an embodiment of the invention, a HyperMessage contains a collection of several HyperWidget instances. As described hereinbefore, a HyperWidget instance receives its value at the viewer side, its local actions are performed at the viewer side and, for example, its server callfore and callback actions, are performed at the server before sending the message to the viewer and after the viewer response, respectively.

The following are examples for singleton HyperWidget instances:
HyperTemplate: A protected string playing as a watermark for the originating HyperTemplate (specified below).
To: the recipient list
From: the sender or senders list. Its protected value is automatically set by the widget definition.
Ignore: a button quit the message viewer without any action i.e. running the quit( ) local callback.
Respond: a button performing a response and exit message viewer, i.e. running the response( ) local callback. According to another embodiment of the invention, Respond may not be a singleton, as there will be more than one Respond buttons with different instance name and possibly different label, executing different responses, for example, directing the response to different recipients.

There may be also other singleton HyperWidgets.

According to an embodiment of the invention, it is possible to implement such singleton as hard coded message fields, however keeping them as HyperWidget instances is more elegant and provides more flexibility to the system, such as creating object oriented derived (inheriting) HyperWidgets. A HyperMessage can have additional variables that are created at the Server HyperMessage thread, together with the variables derived from the HyperWidgets.

The message structure is of a Domain Specific Language (DSL) such as Extensible Markup Language (XML) Schema, or by other format with data representation capabilities that enables interoperability. One (and in some instances the only) step of compression is the binary coding of the DSL.

A HyperMessage has several views automatically derived from the HyperWidget views:
Editing view—to be rendered by the HyperMessage editor;
Responding view—to be rendered by the HyperMessage viewer;
HTML view—to be rendered by a WEB browser. The WEB browser may only be able to perform partial capabilities of HyperMessage viewer, e.g. the WEB browser may not be able to read GPS coordinates;
(Optionally) Text view—to be rendered by a regular text viewer such as SMS viewer. The purpose of this view is to enable partial response capabilities using a text editor. The text view explains what the message is about, what the response options are and how to respond; and
(Optionally) Help view—to be rendered by the HyperMessage viewer help function. The purpose is to enable the viewer understand what are the response options as derived directly from the HyperWidget definitions, and hence to avoid cheating by the creator of the message.

Using the HyperWidget instances and Message Methods, the user creating the HyperMessage can shape the response of the user receiving the HyperMessage in several manners:
He can pre-set the recipient list of the response, for example creating a chain message; and
He can define the response to be a Group Response, which means the receiver of the response will receive a single or collective aggregated response quantifying and representing the entire group response.

HyperTemplate

The term HyperTemplate refers to a form creating a message that belongs to a particular use case or “Message Pattern”, as defined below. A HyperTemplate automatically creates all the message details that are in common to the pattern and leaves to the user to insert values that differ among messages of that pattern. Its role in the system is to make message editing easy, quick, economical, safe and trusted:
Easy—it saves the user editing a message from needing to understand the software paradigms behind HyperMessage composition;
Quick—because the user editing a message needs only to insert values that are needed to turn a common use case into a specific HyperMessage;
Economical—because the transferred data is minimized to the signature, I.e. HyperTemplate ID and its parametric values. This innovative concept opens the door to data transfer so small (i.e., few bytes) that could be done over SMS;
Safe—because it has been widely tested; and
Trusted—because the HyperTemplate is watermarked in the message and its creator can be identified.

A HyperMessage can be created using a HyperTemplate, provided that there is HyperTemplate implementing its use case or “Message Pattern”, as defined below. However, new HyperTemplates could be provided on a need basis, as HyperTemplates are not required to be hard coded in the software. For example, they can be provided in the form of an external add-on that is loaded separately to the client's device even without the need for a software upgrade.

Message Pattern

Message Pattern (MP) refers herein to a general reusable solution to a commonly occurring sequence of messaging. MP is used herein as a theoretical formal representation and is implemented using a single or a set of HyperTemplate: a HyperTemplate can reference and serialize its data into another HyperTemplate that will be sent as a response, and so on. According to an embodiment of the present invention, the implementation of MP is done using a chain or a directed graph of HyperTemplate. For example, a formulation of a message pattern should contain:
A Finite State Machine (FSM) representing the thread flow;
Each state is represented by a HyperTemplate;
Each of the initial state's HyperTemplate is public, i.e. editable and callable;
Each of the non initial HyperTemplate is either protected, i.e. not editable but callable or public;
A transition is represented by a HyperMessage action or simple response with data;
The thread state is derived from all users states;
Every user's FSM can eventually reach its final state
By default every user's FSM has a timeout after which it transits into a final state;
The thread reaches its final state after all users reach their final state; and
When the thread reaches its final state, the thread can be removed from the active threads list and deleted or go to history list.

The deriving capabilities of HyperTemplate enable mass usage. The following are MP Examples:
Vote (poll);
Distributed process among several parties with a well defined Directed Acyclic Graph (DAG) of precedence among them;
Location—e.g., Where are you? With derivatives such as send me directions to you—described in details at the following “Where Are You” example of Message Pattern;
Approval Chain—A request to be approved in a predefined ordered list of recipients—described in details at the Approval Chain Message Pattern; and
Billing—send a bill, pay;—described in details at the Billing Message Pattern.

Following are several examples of Message Pattern:

1. “Where Are You?”

All messages using location are based on reading GPS coordinates and either using the server to provide the map or interfacing with the on device navigation software. Location can be incorporated with many types of messages, such as text message where the sender's location is automatically sent. In one embodiment of the current invention, a message containing a location will have an instance of the GPS HyperWidget. The following example is a Message Pattern of “Where are you?” question followed by “Here I am” response.

In this Pattern, the originator sends a question to one or more recipient “Where Are You?” Some options represented by a Boolean button may be: a) send my location; b) a request for directions to the recipient; and c) group response. The implementation is using three HyperTemplates—a) for the originator; b) for the recipient(s); and c) for the response. The originator fills the recipient list and a question which is by default “Where are you?”. He can modify the Boolean buttons “Send my location”, “Request directions” and “Group Response”. A recipient receives the question. If the originator checked the “Send my location” button then the recipient receives also a map with the originator's location. If the recipient responds then the originator receives a map with the recipient's location. If the originator asked for direction then the map will contain a navigation path and directions to the recipient. If the originator asked for a group response then he will receive a single response containing all recipients and optionally their paths scattered on the map.

2. Approval Chain

In this Message Pattern, the originator issues a request to be approved by a chain of recipients. The data is the request content and the list of approving users. Upon receiving the request, the user can either approve or reject. If approved then the request is forwarded to the next user in the list, else a reject message is sent to the originator. If the last user in the list approves then an approval message is sent to the originator. The implementation is using a single HyperTemplate with two data fields: a) a list of users required to approve; b) a text describing the request. Some derivatives are possible such as c) a Boolean button representing whether each intermediate approval should be reported to the originator. A local callback will set the destination of the response to the top of the list in case of accept or to the originator in case of reject. A server or local callback will pop one user from the top of the approval list and append it to the bottom of a list of users already approved the request.

3. Billing

In this Message Pattern: a) the originator sends a bill to another user; b) the recipient chose either to pay or to reject; if payment was chosen then d) the originator receives a payment confirmation and the recipient receives an invoice; else e) the originator receives a rejection message. The implementation uses a sequence of HyperTemplate, the first one contains the following fields: items and prices, tax rates, discount rates etc. and the originator's credit method selection (if more than one available). The recipient will receive a HyperTemplate-based HyperMessage containing the bill details, final sum and a list of his payment methods selection. Server Callfore actions could be used to automatically instantiate the credit method widget and payment method widget. In this way, the originator sees her credit method, the recipient sees his payment method and the transaction occurs without seeing each other methods.

Client Software

According to an embodiment of the invention, the client software incorporates several components:
Communication module: used for communicating with the server on sending and receiving messages by the client software;
HyperMessage viewer: used for performing the following tasks:
i. Parser for parsing the HyperMessage and activating local event actions (e.g., Callfore);
ii. Rendering module, for rendering the HyperMessage using the responding view of the HyperWidgets;
iii. A viewer enabling the user to view a HyperMessage, inserting values, changing HyperWidgets state and as a result activating local event actions (e.g., callback); and
iv. Upon clicking on Respond HyperWidget (i.e., click event), a local callback event method respond( ) is invoked, composing the response HyperMessage, coding and sending it to the server;
Plain editor: used for performing the following tasks:
i. Enabling the user to edit a new HyperMessage;
ii. Upon user selection of a HyperWidget instances , inserting the editing view of the HyperWidget; and
iii. Upon clicking on a send button (i.e., click event), composing a HyperMessage and sending it to the HyperMessage server.
HyperTemplate based editor: used for enabling the user to insert values into a HyperTemplate (which, as said above is a kind of a form). Upon clicking on a send button (i.e., click event), sending a HyperTemplate signature. Signature means the HyperTemplate ID and its field values.

According to an embodiment of the present invention, there are two types of HyperMessage: a “Detailed HyperMessage” and a “short HyperMessage”, wherein:
Detailed HyperMessage comprises as HyperWidget instances and values, properties, thread variables;
Short HyperMessage comprises HyperTemplate reference and parametric values.

According to an embodiment of the invention, the client software checks whether the HyperTemplate is “known” at the server and accordingly it sends a short HyperMessage, and if it isn't known to the server it sends a detailed HyperMessage. According to another embodiment of the invention, the client software checks whether the HyperTemplate is not “known” at the server and accordingly it sends a HyperTemplate definition. Then it sends short HyperMessage.

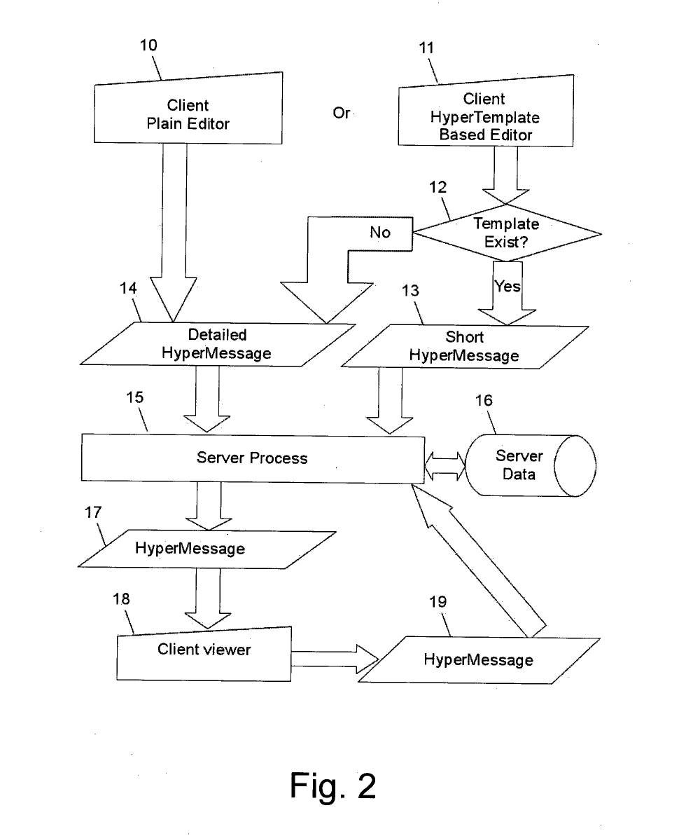

Referring now to FIG. 2, a message flow is described, according to an embodiment of the invention. The flow starts either by the client software plain editor (processing step block 10) or by the client software HyperTemplate based editor (processing step block 11).

If the flow starts by the client software plain editor, then the following tasks are performed (block 10):
instantiating HyperWidgets, and for each instantiated HyperWidget:
   i. assigning name;
   ii. setting data frame (e.g., selection list);
   iii. assigning actions (such as local/server callfore/callback);
   iv. setting more message thread variables;
   v. setting message properties; and
   vi. sending the message.

At the next step a Detailed HyperMessage is generated (data block 14), containing HyperWidget's references and values, Message properties and Thread variables.

If the flow starts by the client software HyperTemplate based editor then the following tasks are performed:
Filling-in data for each editable field; and
Sending the message.

At the next step, decision rhombus block 12, the client software verifies whether the template definition of the original message exists on the server (or it is a private template). If yes, then at the next step the client software will generate and send a Short HyperMessage containing a HyperTemplate reference and values—data block 13. If no, then at the next step the client software will generate and send a Detailed HyperMessage containing HyperWidget's references and values, Message properties and Thread variables—data block 14. An alternative implementation to the latter is that a client will send a HyperTemplate definition to the server and then send a Short HyperMessage.

At the next step, processing block 15 (whether reached from block 13 or 14), the server performs the following tasks:
Decodes and parses the message;
if the message is a Short HyperMessage then creates its derived Detailed HyperMessage;
creating data objects for the message and widgets, using server data (block 16) for storing threads, messages and widgets related to the message;
executing server callback actions; and
For each recipient:
   i. encoding the message and executing server callfore actions; and
   ii. sending the message to recipient.

At the next step a HyperMessage is generated and sent per recipient. It could be either a Short HyperMessage (in case the appropriate HyperTemplate exists on the client) or else a Detailed HyperMessage—data block 17.

At the next step, processing block 18, the message is received at the client software and the message viewer component performs the following tasks:
decoding, parsing and rendering the received message;
activating automatically of local callfore actions;
whenever a user fills-in value(s) and change state of HyperWidgets, then automatically activating of local callback actions; and
whenever the user activates the Response HyperWidget, creating a response message, decoding and sending the message.

At the next step, data block 19, the sent HyperMessage content can be either in form of a Short HyperMessage containing HyperTemplate reference and values or in a form of a detailed HyperMessage containing a collection of HyperWidget references and values. For the sake of simplicity, these two forms are not split into several blocks as shown hereinbefore with respect to blocks 12, 13, and 14. At the next step, the sent message is received at the server for performing the tasks described with respect to processing block 15.

The loop involving blocks 15, 16, 17, 18 and 19 may repeat till the thread reaches into an end, which means the end of the process (or conversation) implemented by interactive messages.

According to the embodiment described hereinbefore, the system and method of the present invention extend the capabilities of mobile phone Short Message Service (SMS) and Instant Message (IM) which runs over an Internet Protocol (IP) and in a similar manner enhances the Electronic mail (Email) and Multimedia Message Service (MMS), by providing new hyper messaging capabilities. Furthermore, it provides a system which is capable of enforcing a messaging contract between sender and recipients together with easy, quick and safe message composition.

The terms, “for example”, “e.g.”, “optionally”, as used herein, are intended to be used to introduce non-limiting examples. While certain references are made to certain example system components or services, other components and services can be used as well and/or the example components can be combined into fewer components and/or divided into further components.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. A method comprising:
generating a message over a platform having instant messaging capability, wherein the generated message comprises at least one widget, being a graphical user interface (GUI) element configured to enable a recipient of the message to set content or manipulate data in the generated message;
sending the generated message from a sender client to at least one recipient client over a web server; and
presenting the generated message to the recipient,
wherein the generating, the sending, and the presenting are executed by at least one computer processor.

2. The method according to claim 1, further comprising updating and storing data elements related to the generated message, wherein the storing is carried out at the web server.

3. The method according to claim 1, further comprising activating event actions responsive to the generated message, wherein the activating is carried out at least at: the web server, and the client recipient.

4. The method according to claim 1, further comprising at least one of the following actions carried out at the recipient client, where applicable: decoding, parsing and rendering the generated message; automatically activating of local event actions, automatically activating the local callback event actions and creating, decoding and sending a return message.

5. The method according to claim 1, wherein the generating of a message comprises: instantiating widget, and for each instantiated widget: assigning name; setting data frame; assigning event actions; setting widget as protected if necessary setting more message thread variables; and setting message properties.

6. The method according to claim 1, wherein the generating further comprises providing a template definition, wherein the template definition enables generating the new message by filling-in data for each editable field.

7. The method according to claim 5, further comprising verifying whether template definition exists on the web server, and if said definition exists, then creating a template based message else creating a widget based message.

8. The method according to claim 2, wherein the updated and stored data includes threads, messages content and data elements related to widgets and their values.

9. The method according to claim 1, further comprising implementing a Message Pattern which is a general reusable solution to a commonly occurring sequence of interactive messages, wherein said Message Pattern is implemented by using a single or a set of template and wherein at least part of the data may be processed and transferred from an interactive message into the following interactive message.

10. The method according to claims 5, 6 and 9, wherein the first message among the occurring sequence of interactive messages is generated using a template and all other messages that follow said first message may be generated using a template or may be generated directly by a dedicated code.

11. The method according to claim 10, wherein the dedicated code can be a local callback of a sending button or a server event action of the message.

12. The method according to claim 9, wherein the Message Pattern includes: a. Formal definition using a Finite State Machine (FSM) representing the interactive message thread flow, wherein each state either initial or non-initial is represented by a template, wherein each initial state is public, and each non-initial state is either protected or public; a transition which is represented by a HyperMessage action or a simple response with data; the thread state is derived from all users states; By default every user's FSM has a timeout after which it transits into a final state; The thread reaches its final state after all users reach their final state; and When the thread reaches its final state, the thread can be removed from the active threads list and deleted or go to a history list.

13. A system comprising:
a plurality of computer processors;
a sender client configured to generate a message over an instant messaging platform, wherein the generated message comprises at least one widget, being a graphical user interface (GUI) element configured to enable a recipient of the message to set content or manipulate data in the generated message;
a web server configured to receive and process the generated message from a sender client and send it to a recipient client; and
a recipient client configured to present the generated message to the recipient,
wherein the sender client, the web server, and the recipient client are executed by at least one of the plurality of computer processors.
